(19) United States
(12) Patent Application Publication
(10) Pub. No.: US 2022/0378241 A1
(43) Pub. Date: Dec. 1, 2022

(54) APPARATUS AND METHOD FOR HEATING A LIQUID

(71) Applicant: VESTEL ELEKTRONIK SANAYI VE TICARET A.S., Manisa (TR)

(72) Inventors: Murat DEMIR, Manisa (TR); Gürmen KAHRAMANOGLU, Manisa (TR); Sezgin HILAVIN, Manisa (TR)

(73) Assignee: VESTEL ELEKTRONIK SANAYI VE TICARET A.S., Manisa (TR)

(21) Appl. No.: 17/776,567

(22) PCT Filed: Nov. 12, 2019
(86) PCT No.: PCT/EP2019/080919

§ 371 Date: May 12, 2022

(51) Int. Cl. A47J 27/21

(52) U.S. Cl. CPC A47J 27/21191; A47J 27/21083

(57) ABSTRACT

The present disclosure relates to an apparatus (100) for heating a liquid. The apparatus (100) includes a temperature sensor (110) configured to sense a temperature of the liquid; an inclination sensor (120) configured to sense an inclination of the apparatus (100); and an adjustment unit (130) configured to adjust a size of a liquid outlet (132) of the apparatus (100) based on the sensed temperature and inclination.

### FIELD

Embodiments of the present disclosure relate to an apparatus for heating a liquid, a method for heating a liquid, and a computer readable storage medium for executing the method. Embodiment of the present disclosure particularly relate to a water kettle providing an improved safety for users.

### BACKGROUND

Nowadays, a kettle is one of the most commonly used household appliances in kitchens. A kettle is a type of a pot, configured to boil water, with a lid, spout, and handle, or a small kitchen appliance of similar shape that functions in a self-contained manner Kettles can be heated either by placement on a stove, or by their own internal electric heating element.

These frequently used devices have various safety problems. One of these problems is that boiling liquid can splash out of a liquid outlet of the kettle and injure a user. For example, when the boiling liquid is poured into an external container, the boiling liquid can splash and injure the user.

In view of the above, new apparatuses for heating a liquid, methods for heating a liquid, and computer readable storage media for executing the method, that overcome at least some of the problems in the art are beneficial.

### SUMMARY

In light of the above, an apparatus for heating a liquid, a method for heating a liquid, and a computer readable storage medium for executing the method are provided.

It is an object of the present disclosure to prevent injuries when a user pours a boiling liquid into an external container, such as a cup. Further objects, aspects, benefits, and features of the present disclosure are apparent from the claims, the description, and the accompanying drawings.

According to an independent aspect of the present disclosure, an apparatus for heating a liquid is provided. The apparatus includes a temperature sensor configured to sense a temperature of the liquid; an inclination sensor configured to sense an inclination of the apparatus e.g. with respect to a reference plane; and an adjustment unit configured to adjust a size of a liquid outlet of the apparatus based on the sensed temperature and inclination.

According to another independent aspect of the present disclosure, a method for heating a liquid is provided. The method includes sensing a temperature of the liquid; sensing an inclination of a container containing the liquid e.g. with respect to a reference plane; and adjusting a size of a liquid outlet based on the sensed temperature and inclination.

According to another independent aspect of the present disclosure, a computer readable storage medium storing one or more programs is provided, the one or more programs comprising instructions that, when executed by one or more processors of an apparatus, cause the apparatus to: sense a temperature of the liquid in a container; sense an inclination of the container e.g. with respect to a reference plane; and adjust a size of a liquid outlet based on the sensed temperature and inclination.

Embodiments are also directed at devices for carrying out the disclosed methods and include device parts for performing each described method aspect. These method aspects may be performed by way of hardware components, a computer programmed by appropriate software, by any combination of the two or in any other manner. Furthermore, embodiments according to the disclosure are also directed at methods for operating the described apparatus. The methods include method aspects for carrying out every function of the apparatus.

### BRIEF DESCRIPTION OF THE DRAWINGS

So that the manner in which the above recited features of the present disclosure can be understood in detail, a more particular description of the disclosure, briefly summarized above, may be had by reference to embodiments. The accompanying drawings relate to embodiments of the disclosure and are described in the following:

FIG. 1 shows a schematic view of an apparatus for heating a liquid according to various embodiments described herein;

FIG. 2 shows exemplary angles of the apparatus with respect to a reference plane according to embodiments described herein; and

FIG. 3 shows different inclinations and corresponding opening degrees of the liquid outlet according to embodiments described herein.

### DETAILED DESCRIPTION OF EMBODIMENTS

Reference will now be made in detail to the various embodiments of the disclosure, one or more examples of which are illustrated in the figures. Within the following description of the drawings, the same reference numbers refer to same components. Generally, only the differences with respect to individual embodiments are described. Each example is provided by way of explanation of the disclosure and is not meant as a limitation of the disclosure. Further, features illustrated or described as part of one embodiment can be used on or in conjunction with other embodiments to yield yet a further embodiment. It is intended that the description includes such modifications and variations.

Household appliances such as kettles have various safety problems. One of these problems is that boiling liquid can splash out of a liquid outlet of the kettle and injure a user. For example, when the boiling liquid is poured into an external container, the boiling liquid can splash and injure the user.

The present disclosure overcomes these disadvantages by varying an opening degree or size of the liquid outlet of the kettle according to the liquid temperature and the angle e.g. between the base surface of the kettle and the floor surface. Thereby, injuries can be prevented when a user pours a boiling liquid into an external container, such as a cup.

In particular, under normal conditions, the angle of the kettle base with respect to the ground surface is 0° or 90° (depending on a definition of the angle). The temperature of the liquid in the kettle may be continuously measured and recorded. When the (bowing) angle changes e.g. to pour the liquid into an external container such as a cup, the temperature information of the liquid may be checked. If the temperature of the liquid is high, the outlet of the kettle (spout) may be narrowed due to the increased bowing angle. Thereby, injuries can be prevented when a user pours a boiling liquid into an external container, such as a cup.

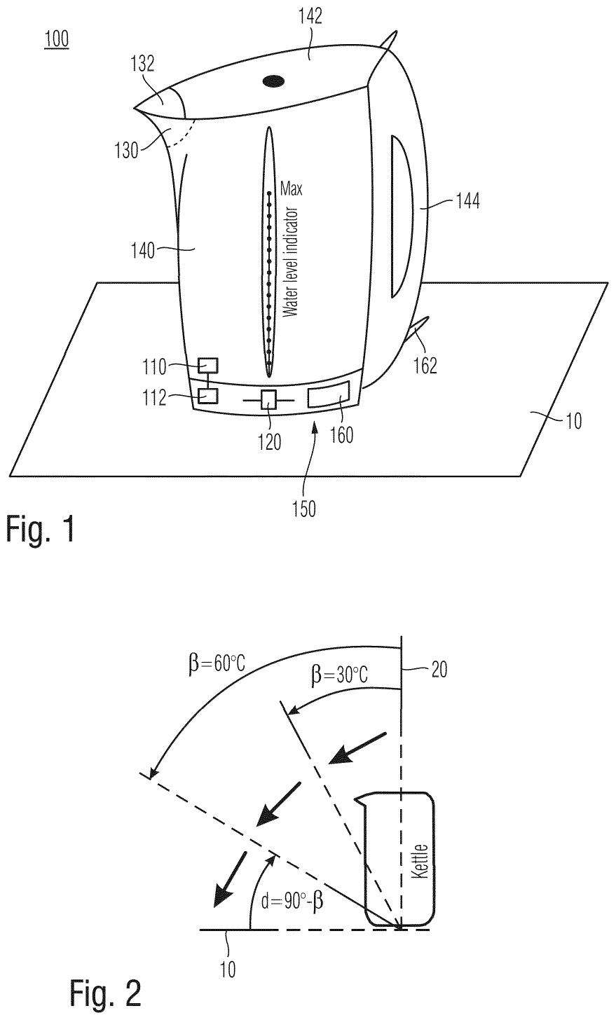

FIG. 1 shows a schematic view of an apparatus 100 for heating a liquid according to embodiments described herein.

In some implementations, the apparatus 100 may be a kettle or boiler and/or the liquid may be water. In particular, the apparatus 100 may be a water kettle or water boiler.

The apparatus 100 includes a body 140 having a container configured to contain the liquid. The body 140 may further include a lid 142 configured to cover the container at a top of the body 140. The body 140 further includes a liquid outlet 132, which may be referred to as “spout”. Furthermore, the body 140 may include a handle 144 or grip which allows a user to lift the body 140.

The body 140 may be connected to a base 150. In the example shown in FIG. 1, the body 140 is fixedly attached to the base 150. Alternatively, the body 140 may be detachably attached to the base 150 such that the body 140 can be separated from the base 150.

The apparatus 100 further includes a power source 160. The power source 160 may include a cable having a plug which is connectable to a socket. Additionally, or alternatively, the power source 160 may include a rechargeable power source, such as a battery.

According to some embodiments, the apparatus 100 may include one or more heaters (not shown) configured to heat the liquid inside the body 140. The one or more heaters can be switched on and off by means of a switch 162. Alternatively, the apparatus 100 may not include heaters. In such a case, the apparatus 100 may be put on a stove or other heat source to heat the liquid inside the container of the apparatus 100.

The apparatus 100 of the present disclosure includes a temperature sensor 110 configured to sense a temperature of the liquid, which may be displayed on a display 112. The apparatus 100 further includes an inclination sensor 120 configured to sense an inclination of the apparatus 100 e.g. with respect to a reference plane 10; and an adjustment unit 130 configured to adjust a size of the liquid outlet 132 of the apparatus 100 based on the sensed temperature and inclination.

The reference plane 10 may be an essentially horizontally oriented plane, such as a table surface, kitchen counter, or countertop.

The term “horizontal direction” or “horizontal orientation” is understood to distinguish over “vertical direction” or “vertical orientation”. That is, the “horizontal direction” or “horizontal orientation” relates to a substantially horizontal orientation e.g. of the reference plane 10, wherein a deviation of a few degrees, e.g. up to 10° or even up to 15°, from an exact horizontal direction or horizontal orientation is still considered as an “essentially horizontal direction” or an “essentially horizontal orientation”. The vertical direction can be substantially parallel to the force of gravity.

The inclination sensor 120 of the apparatus 100 is configured to sense the inclination, i.e. an angle, of the apparatus 100 e.g. with respect to the reference plane 10. The inclination or angle can be defined with respect to a reference orientation of the apparatus 100, e.g. when a lower surface of the apparatus 100 is entirely supported by the table surface, kitchen counter, or countertop. The reference orientation may correspond to an inclination or angle of 0° or 90° (depending on the definition of the inclination or angle).

According to some embodiments, which can be combined with other embodiments described herein, the inclination sensor 120 may be configured to operate based on gravity. In other words, the inclination sensor 120 may be a gravity or G-sensor.

The safety system of the present disclosure, which includes the temperature sensor 110, the inclination sensor 120, and the adjustment unit 130, may be energized by the rechargeable power source 160 in the base 150 of the apparatus 100. The rechargeable power source 160 can be charged when it is connected to an external power source, such as an external base of the apparatus 100.

In some implementations, the adjustment unit 130 is configured to adjust the size of the liquid outlet 132 of the apparatus 100 only when the temperature sensed by the temperature sensor 110 is equal to or greater than a predetermined reference temperature. The predetermined reference temperature may be 40° C. or above, 45° C. or above, or 50° C. or above. For example, the predetermined reference temperature may be about 48° C.

According to another aspect of the present disclosure, a method for heating a liquid is provided. The method includes sensing a temperature of the liquid; sensing an inclination of a container containing the liquid e.g. with respect to a reference plane; and adjusting a size of a liquid outlet based on the sensed temperature and inclination.

The method may be implemented using software. In particular, a computer readable storage medium may be provided which stores one or more (software) programs, the one or more programs comprising instructions that, when executed by one or more processors of the apparatus 100 for heating a liquid, cause the apparatus 100 to implement the above-described method.

The computer readable storage medium may be included in a controller of the apparatus 100.

FIG. 2 shows exemplary inclinations or angles of the apparatus 100 according to embodiments described herein.

The inclination or angle of the apparatus 100 can be defined in any suitable way. The inclination or angle can be defined with respect to the reference plane 10 Alternatively, the inclination or angle can be defined with respect to a vertical direction 20. In the present disclosure, the inclination or angle defined with respect to the reference plane 10 is designated as a.

In one example, a is defined as (90°−β), i.e. α=(90°−β), wherein β is the inclination or angle of the apparatus 100 with respect to the vertical direction 20. An inclination or angle of β=0°, i.e. α=90°, may correspond to the reference orientation of the apparatus 100.

Alternatively, in another example, the inclination or angle α of the apparatus 100 is defined as β, i.e., α=β.

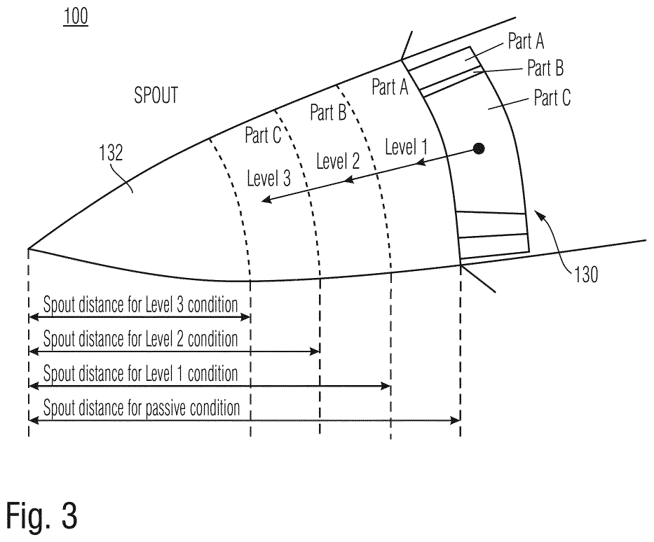

FIG. 3 shows different inclinations and corresponding opening degrees of the liquid outlet 132 of the apparatus 100 according to embodiments of the present disclosure.

According to some embodiments, which can be combined with other embodiments described herein, the adjustment unit 130 is configured to adjust the opening degree or size of the liquid outlet 132 according to inclination intervals of the apparatus 100. The inclination intervals may include two or more inclination intervals, such as three of more inclination intervals.

The inclination intervals may include at least a first interval corresponding to a first opening degree or size of the liquid outlet 132 and a second interval corresponding to a second opening degree or size of the liquid outlet 132. Optionally, the inclination intervals may include a third interval corresponding to a third opening degree or size of the liquid outlet 132.

The first opening degree or size may be larger than the second opening degree or size, and the second opening degree or size may be larger than the third opening degree or size. Alternatively, the first opening degree or size may be smaller than the second opening degree or size, and the second opening degree or size may be smaller than the third opening degree or size. In any case and depending of the definition of the intervals and/or inclination, the opening degree or size is smaller the larger the inclination is. This can improve a safety of the apparatus 100 and prevent the user from being injured by splashing liquid.

In some implementations, each of the intervals corresponds to an angle range of about 30°. For example, the first interval may be β=0° to 30° (“first level”); the second interval may be β=30° (or 31°) to 60° (“second level”); and the third interval may be β=60° (or 61°) to 90° (“third level”).

FIG. 3, illustrates the opening degrees of the liquid outlet 132 for the first level, the second level and the third level. The opening degree or size of the liquid outlet 132 is smaller the higher the inclination or level is, and is larger the smaller the inclination or level is. In other words, the opening degree or size of the liquid outlet 132 is the highest for the first level and is smallest for the third level.

According to some embodiments, which can be combined with other embodiments described herein, the adjustment unit 130 is configured to adjust the size of the liquid outlet 132 of the apparatus 100 mechanically and/or electrically.

For example, the adjustment unit 130 may include a plurality of moveable units (designated as parts A-C in FIG. 3), which are configured to cover the liquid outlet 132. The plurality of moveable units may be successively moved to increase or reduce the opening degree or size of the liquid outlet 132 based on the inclination or angle of the apparatus 100.

In some implementations, the adjustment unit 130 may include a stepper motor to move the plurality of moveable units. However, the present disclosure is not limited thereto and the adjustment unit 130 may include other mechanical and/or electrical means to adjust the opening degree or size of the liquid outlet 132 of the apparatus 100.

The safety mechanism to adjust the opening degree or size of the liquid outlet 132 based on the inclination or angle of the apparatus 100 may only be activated when the temperature sensed by the temperature sensor is equal to or greater than a predetermined reference temperature. The predetermined reference temperature may be 40° C. or above, 45° C. or above, or 50° C. or above. For example, the predetermined reference temperature may be about 48° C.

According to the present disclosure, the temperature of the liquid in the kettle may be continuously measured and recorded. When the (bowing) angle changes e.g. to pour the liquid into an external container such as a cup, the temperature information of the liquid may be checked. If the temperature of the liquid is high, the outlet of the kettle (spout) may be narrowed due to the increased bowing angle. Thereby, injuries can be prevented when a user pours a boiling liquid into an external container, such as a cup.

While the foregoing is directed to embodiments of the disclosure, other and further embodiments of the disclosure may be devised without departing from the basic scope thereof, and the scope thereof is determined by the claims that follow.

1. An apparatus (100) for heating a liquid, comprising:
a temperature sensor (110) configured to sense a temperature of the liquid;
an inclination sensor (120) configured to sense an inclination of the apparatus (100); and
an adjustment unit (130) configured to adjust a size of a liquid outlet (132) of the apparatus (100) based on the sensed temperature and inclination.

2. The apparatus (100) of claim 1, wherein the inclination sensor (120) is configured to sense the inclination of the apparatus (100) with respect to a reference plane (10), wherein the reference plane (10) is an essentially horizontally oriented plane.

3. The apparatus (100) of claim 1 or 2, wherein the inclination sensor (120) is configured to operate based on gravity.

4. The apparatus (100) of any one of claims 1 to 3, wherein the adjustment unit (130) is configured to adjust the size of the liquid outlet (132) of the apparatus (100) only when the temperature sensed by the temperature sensor (110) is equal to or greater than a predetermined reference temperature.

5. The apparatus (100) of claim 4, wherein the predetermined reference temperature is 40° C. or above, 45° C. or above, or 50° C. or above, in particular wherein the predetermined reference temperature is 48° C.

6. The apparatus (100) of any one of claims 1 to 5, wherein the adjustment unit (130) is configured to adjust the size of the liquid outlet (132) according to inclination intervals of the apparatus (100).

7. The apparatus (100) of claim 6, wherein the inclination intervals are two or more inclination intervals.

8. The apparatus (100) of claim 7, wherein the inclination intervals include at least a first interval corresponding to a first opening degree of the liquid outlet (132) and a second interval corresponding to a second opening degree of the liquid outlet (132).

9. The apparatus (100) of claim 8, wherein the inclination intervals include a third interval corresponding to a third opening degree of the liquid outlet (132).

10. The apparatus (100) of claim 8, wherein:
the first interval is between 0° and 30°;
the second interval is between 30°, particularly 31°, and 60°; and
the third interval is between 60°, particularly 61°, and 90°.

11. The apparatus (100) of any one of claims 1 to 10, wherein the adjustment unit (130) is configured to adjust the size of the liquid outlet (132) of the apparatus (100) mechanically and/or electrically.

12. The apparatus (100) of any one of claims 1 to 11, wherein the adjustment unit (130) includes a stepper motor.

13. The apparatus (100) of any one of claims 1 to 12, wherein the apparatus (100) is a water kettle.

14. A method for heating a liquid, comprising:
sensing a temperature of the liquid;
sensing an inclination of a container containing the liquid; and
adjusting a size of a liquid outlet (132) of the container based on the sensed temperature and inclination.

15. A computer readable storage medium storing one or more programs, the one or more programs comprising instructions that, when executed by one or more processors of an apparatus (100) for heating a liquid, cause the apparatus (100) to:
sense a temperature of the liquid in a container;
sense an inclination of the container; and
adjust a size of a liquid outlet (132) based on the sensed temperature and inclination.
